(19) United States
(12) Patent Application Publication
(10) Pub. No.: US 2021/0183196 A1
(43) Pub. Date: Jun. 17, 2021

(54) PAPER SHEET PROCESSING DEVICE AND PAPER SHEET PROCESSING SYSTEM

(71) Applicant: GLORY LTD., Hyogo (JP)

(72) Inventors: Masao SAKAMOTO, Himeji-shi, Hyogo (JP); Keisuke NADA, Himeji-shi, Hyogo (JP); Yoshikatsu MIZUSHIMA, Himeji-shi, Hyogo (JP); Mitsushi NAGAO, Himeji-shi, Hyogo (JP); Minoru HIGASHIYAMA, Himeji-shi, Hyogo (JP)

(21) Appl. No.: 16/769,608

(22) PCT Filed: Nov. 13, 2018
(86) PCT No.: PCT/JP2018/042017

§ 371 Date: Jun. 4, 2020

(30) Foreign Application Priority Data
Dec. 5, 2017 (JP) 2017-233511

(51) Int. Cl. G07D 7/0047; G07D 11/225; G06K 9/00

(52) U.S. Cl. CPC G07D 7/0047; G06K 9/00442; G07D 11/225

(57) ABSTRACT

Provided is a paper sheet processing device that is capable of efficiently distinguishing and processing banknotes to be distinguished. This paper sheet processing device is provided with: an identification unit that identifies serial numbers added to paper sheets; and a control unit that executes identification of the paper sheets on the basis of the serial numbers identified by the identification unit, and a serial number list which includes the serial numbers and additional information associated with at least one of the serial numbers.

### TECHNICAL FIELD

The present invention relates to a sheet processing apparatus that processes a sheet, and a sheet processing system that comprises such a sheet processing apparatus.

### BACKGROUND ART

Conventionally, a sheet processing apparatus that processes a specific banknote such as a counterfeit note by distinguishing the specific banknote from other banknotes has been commercialized.

Such a sheet processing apparatus, as disclosed in Patent Literature (hereinafter, referred to as “PTL”) 1, for example, distinguishes and processes banknotes that should be distinguished, by using a serial number list that is a list of serial numbers attached to the banknotes that should be distinguished.

### CITATION LIST

### Patent Literature

### PTL 1

### Japanese Patent Application Laid-Open No. 2013-218420

### SUMMARY OF INVENTION

### Technical Problem

An object of the present invention is to efficiently perform sheet processing that is performed by distinguishing sheets that should be distinguished.

### Solution to Problem

A sheet processing apparatus according to the present invention comprises: a recognition unit that recognizes a serial number attached to a sheet; and a control section that executes determination of the sheet based on the serial number recognized by the recognition unit, and a serial number list including a plurality of the serial numbers and additional information associated with at least one of the plurality of serial numbers.

### Advantageous Effects of Invention

According to the present invention, it is possible to efficiently perform sheet processing that is performed by distinguishing sheets that should be distinguished.

### BRIEF DESCRIPTION OF DRAWINGS

FIG. 1 is a schematic diagram of a sheet processing apparatus according to an embodiment;

FIG. 2A is an example of a serial number list;

FIG. 2B is another example of the serial number list;

FIG. 3 is still another example of the serial number list;

FIG. 4 is yet another example of the serial number list;

FIG. 5 is further another example of the serial number list;

FIG. 6 is a schematic diagram of a banknote processing system;

FIG. 7A is an example of the serial number list before a version upgrade; and

FIG. 7B is an example of the serial number list after the version upgrade.

### DESCRIPTION OF EMBODIMENTS

Hereinafter, the present invention will be described in detail with reference to the drawings. Note that, in the following description, the “front” of a sheet processing apparatus means a side of an operator who performs at least one operation of sheet input operation and sheet discharge operation through an opening section described later, and the “rear” of the sheet processing apparatus means the opposite side thereto. Further, the “left” of the sheet processing apparatus means the left side when viewed from the operator, and the “right” of the sheet processing apparatus means the right side when viewed from the operator.

Further, in the present specification, a “normal banknote” refers to a banknote that can be recognized by a recognition unit described later, and a “rejected banknote” refers to a banknote that cannot be recognized by the recognition unit. A “fit note” refers to, among normal banknotes, a banknote with relatively little stain, tear, and/or the like, and an “unfit note” refers to, among normal banknotes, a banknote with a relatively large amount of stain, tear, and/or the like.

Further, in the present specification, a “counterfeit note” refers to, among normal banknotes, a banknote (precisely, a piece of paper that imitates but is not a banknote) that is not issued by a legitimate issuing institution. A “genuine note” refers to, among normal banknotes, a banknote that is issued by a legitimate issuing institution. A “stolen note” refers to, among genuine notes, a banknote that is stolen or is handed over as a ransom.

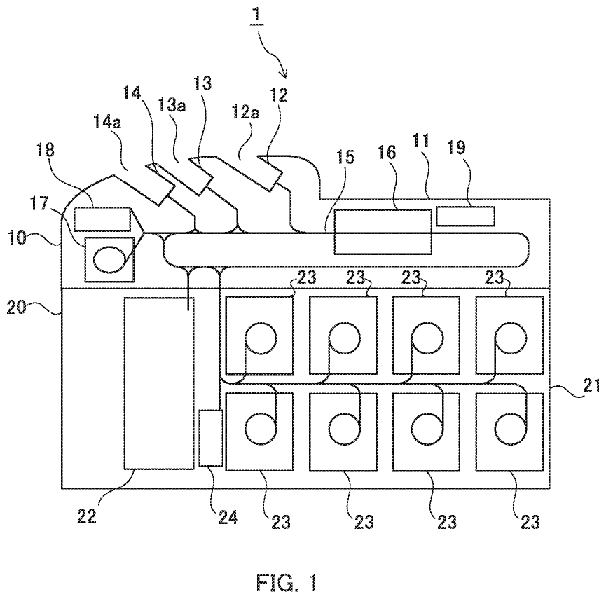

FIG. 1 illustrates a banknote processing apparatus 1 as a sheet processing apparatus according to Embodiment 1 of the present invention. In FIG. 1, the left side is a front portion of the banknote processing apparatus 1, and the right side is a rear portion of the banknote processing apparatus 1.

The banknote processing apparatus 1 is a banknote depositing and dispensing machine to/from which a banknote as a sheet is deposited/withdrawn. The banknote processing apparatus 1 comprises a processing section 10, and a storage compartment 20 provided below the processing section 10.

The processing section 10 comprises an upper housing 11. An inlet (opening) 12a, an outlet (opening) 13a, and a reject port (opening) 14a are provided on an upper front portion of the upper housing 11. A transport unit 15, a recognition unit 16, a temporary storage section 17, a first reject box 18, and a control section 19 are disposed in the upper housing 11.

A banknote feeding mechanism (not illustrated) that feeds out banknotes one by one to the transport unit 15 in a predetermined cycle is disposed near the inlet 12a. The inlet 12a and the banknote feeding mechanism configure a depositing section 12.

A stacking mechanism (not illustrated) that stacks the banknotes is disposed near the outlet 13a. The outlet 13a and the stacking mechanism configure a withdrawal section 13.

A stacking mechanism (not illustrated) that stacks the banknotes is disposed near the reject port 14a. The reject port 14a and the stacking mechanism configure a reject section 14.

Note that, in an upper front portion of the processing section 10, a depositing and withdrawal section may be provided, by providing an opening through which both the depositing and withdrawal of the banknotes are performed, and by disposing a banknote feeding mechanism and a stacking mechanism around the opening. In the present specification, the depositing section 12, the withdrawal section 13, the depositing and withdrawal section, and the reject section 14 are collectively referred to as the opening section.

The transport unit 15 transports the banknotes at a predetermined transport speed. The transport unit 15 is configured with a belt mechanism and/or a roller mechanism for transporting the banknotes. The transport unit 15 is configured with a loop-shaped transport path that enables the banknotes to be transported bi-directionally, and a plurality of diversion paths that are diverged from the loop-shaped transport path. Each diversion path connects the loop-shaped transport path to the depositing section 12, the withdrawal section 13, and the reject section 14, respectively, as well as connects the loop-shaped transport path to the temporary storage section 17 described later, the first reject box 18 described later, a second reject box 24 described later, a first storage unit 22 described later, and a second storage unit 23 described later, respectively.

The recognition unit 16 comprises a sensor such as an image sensor, an optical sensor and a magnetic sensor, and recognizes authenticity, denomination, fitness, and/or the like of the banknotes transported by the transport unit 15. As described later, the recognition unit 16 performs two types of recognition of primary recognition and secondary recognition.

The temporary storage section 17 temporarily stores the banknotes. The temporary storage section 17 takes in and stores the banknotes one by one, and feeds out the stored banknotes one by one. The temporary storage section 17 can be configured with, for example, a winding-type storage unit in which a plurality of banknotes are stored in a state of being wound around a rotating body.

The first reject box 18 is a container, and stores a banknote recognized by the recognition unit 16 as a predetermined banknote (for example, a counterfeit note) that should be processed by distinguishing the banknote from other banknotes.

The control section 19 comprises at least a CPU and a memory. The control section 19 integrally controls the banknote processing apparatus 1 by controlling each unit and section configuring the banknote processing apparatus 1 such that the banknotes are transported to predetermined positions through the transport unit 15. The memory records a program that is executed by the CPU for integrally controlling the banknote processing apparatus 1, a serial number list that is a list of serial numbers attached to banknotes that should be distinguished and processed, and/or the like.

The storage compartment 20 comprises a lower housing 21.

The first storage unit 22 is disposed on a side of a front portion in the lower housing 21. The first storage unit 22 is a lamination-type storage unit in which a plurality of banknotes are stored in a state of being laminated. The first storage unit 22 is connected to a diversion path of the transport unit 15. The first storage unit 22 can also be used as a collection section in which banknotes to be collected from the banknote processing apparatus 1 are stored.

Eight of the second storage units 23 are disposed on a side of a rear portion in the lower housing 21. The second storage unit 23 is a winding-type storage unit in which a plurality of banknotes are stored in a state of being wound around a rotating body. Each of the second storage units 23 is connected to a diversion path of the transport unit 15.

The second reject box 24 is disposed in the lower housing 21, for example, between the first storage unit 22 and the second storage unit 23. The second reject box 24 is a container, and stores a banknote recognized by the recognition unit 16 as a predetermined banknote (for example, a counterfeit note) that should be processed by distinguishing the banknote from other banknotes. The second reject box 24 is connected to a diversion path of the transport unit 15.

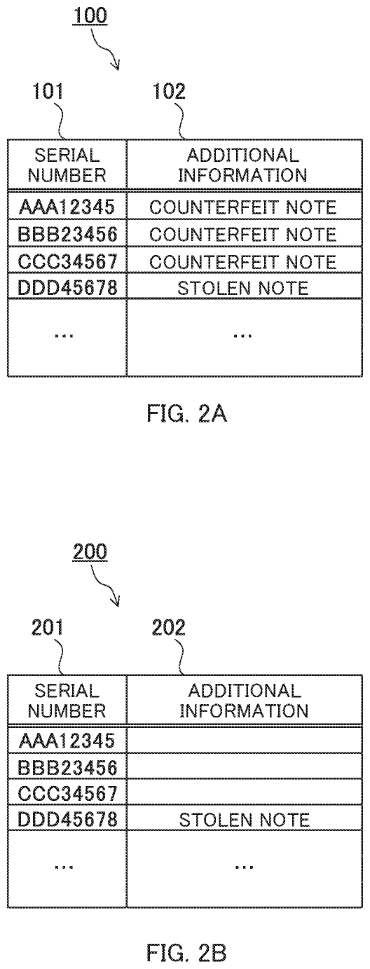

Subsequently, a description will be given of the serial number list that the banknote processing apparatus 1 according to the present embodiment uses when performing banknote processing. The serial number list represents structured data that can be processed by e.g. the CPU that the control section 19 comprises, and is shown in a tabular form as illustrated in FIG. 2A, for example, by processing the data with a predetermined program. Hereinafter, the data and the tabular form shown by processing the data are collectively referred to as the serial number list for convenience.

Note that, in the following description, the serial number list is recorded in the memory that the control section 19 comprises, but may be recorded in an external storage apparatus capable of communicating with the banknote processing apparatus 1. In this case, the banknote processing apparatus 1 is capable of performing banknote processing by receiving the serial number list from the external storage apparatus and using the received serial number list.

FIG. 2A illustrates a serial number list 100 that is an example of the serial number list. The serial number lists 100 is configured with a column 101 and a column 102.

The column 101 lists serial numbers attached to banknotes that need or may need to be distinguished and processed. The banknotes that need to be distinguished and processed are, for example, counterfeit notes.

The column 102 lists additional information associated with the serial numbers listed in the column 101. The additional information listed in the column 102 is additional information on counterfeit note or on stolen note.

The banknote processing apparatus 1 uses the serial number list 100 as such to execute depositing processing as described below, for example. Note that, in the following description, it is assumed that the secondary recognition is performed after the primary recognition, but the order of these may be reversed.

First, the depositing section 12 takes in a banknote. The transport unit 15 transports the taken-in banknote to the recognition unit 16. The recognition unit 16 and the control section 19 perform the primary recognition for the banknote. The primary recognition represents processing in which the recognition unit 16 reads (recognizes) various information from the banknote by using the sensor, and the control section 19 uses the various information to determine the authenticity, denomination, fitness, and/or the like of the banknote.

A banknote whose type cannot be determined in the primary recognition is determined as a rejected banknote regardless of a result of the secondary recognition described later, and is transported to, for example, the reject section 14. In a case where the primary recognition is performed before the secondary recognition described later, the secondary recognition for the banknote determined as a rejected banknote in the primary recognition may not be performed. A banknote determined as a normal banknote in the primary recognition is subjected to comprehensive banknote determination that is performed together with the result of the secondary recognition.

The secondary recognition is performed following the primary recognition. The secondary recognition represents processing in which the recognition unit 16 reads (recognizes) a serial number of a banknote by using an image sensor or the like, and the control section 19 determines whether or not the banknote is a banknote to be distinguished based on the read serial number and the serial number list 100 recorded in the memory of the control section 19. Specifically, in a case where the additional information is associated with the serial number which coincides with the serial number read by the recognition unit 16, in the column 101, the control section 19 determines that the banknote corresponds to the additional information and should be processed by distinguishing the banknote from other banknotes.

As a result of the secondary recognition, banknotes for which it is determined that serial numbers associated with the additional information “COUNTERFEIT NOTE” or “STOLEN NOTE” are attached to the banknotes, that is, banknotes determined as counterfeit notes or stolen notes are processed by distinguishing the banknotes from other banknotes even when it is not determined as such in the primary recognition. That is, these banknotes are transported to, for example, the first reject box 18 or the second reject box 24, and are stored by distinguishing the banknotes from other banknotes.

Note that, a banknote which is determined as a counterfeit note in the primary recognition and for which it is determined in the secondary recognition that a serial number associated with the additional information “STOLEN NOTE” is attached to the banknote is comprehensively determined as a stolen note (not a counterfeit note, but a genuine note). (That is, the result of the secondary recognition takes precedence over the result of the primary recognition.) A banknote thus determined is transported to the first reject box 18 or the second reject box 24 that is configured to store stolen notes so that the banknote can be stored by distinguishing the banknote from other banknotes.

A normal banknote that is not determined as a banknote to be distinguished in the secondary recognition is determined as a genuine note or a counterfeit note based on the result of the primary recognition. Banknotes which are determined as genuine notes in the primary recognition and which are not determined as banknotes to be distinguished in the secondary recognition are comprehensively determined as genuine notes, are physically divided by type of denomination or the like by the transport unit 15, and are transported to and stored in the first storage unit 22 or the second storage unit 23. Banknotes which are determined as counterfeit notes in the primary recognition and which are not determined as banknotes to be distinguished in the secondary recognition are comprehensively determined as counterfeit notes.

The banknote processing apparatus 1 according to the present embodiment is capable of distinguishing and processing two types of banknotes that should be distinguished, namely counterfeit notes and stolen notes, not by using two serial number lists of a serial number list relating to counterfeit notes and a serial number list relating to stolen notes, but by using one serial number list that is the serial number list 100.

Accordingly, banknote processing can be performed conveniently and efficiently.

Further, banknotes regarded as counterfeit notes and banknotes regarded as stolen notes may be physically divided and stored. For example, the banknotes regarded as counterfeit notes may be stored in the first reject box 18, and the banknotes regarded as stolen notes may be stored in the second reject box 24. By separating the banknotes regarded as counterfeit notes and the banknotes regarded as stolen notes in advance in a depositing processing stage, the banknotes regarded as counterfeit notes and the banknotes regarded as stolen notes can be handled efficiently, respectively, in a case where subsequent ways to handle counterfeit notes and stolen notes are different from each other.

Note that, although the serial number list 100 illustrated in FIG. 2A comprises two types of additional information, namely “COUNTERFEIT NOTE” and “STOLEN NOTE”, there may be one type of additional information that is clearly indicated as in a serial number list 200 illustrated in FIG. 2B, for example.

The serial number list 200 illustrated in FIG. 2B is configured with a column 201 and a column 202. The serial number list 200 can be used in at least two ways.

One way to use the serial number list 200 is a case where only serial numbers relating to counterfeit notes are listed in the column 201. In this case, the serial numbers (AAA12345, BBB23456, and CCC34567) whose corresponding boxes in the column 202 are blank are serial numbers relating to counterfeit notes. Further, the serial number (DDD45678) whose corresponding box in the column 202 comprises a description “STOLEN NOTE” is a serial number relating to a counterfeit note and a stolen note at the same time.

Another way to use the serial number list 200 is a case where serial numbers relating to counterfeit notes and serial numbers relating to stolen notes are listed in the column 201. In this case, the serial numbers whose corresponding boxes in the column 202 are blank are serial numbers relating to counterfeit notes. Further, the serial number whose corresponding box in the column 202 comprises a description “STOLEN NOTE” is a serial number relating to a stolen note.

Whichever way is adopted, the serial number list 200 substantially comprises two types of additional information, namely “COUNTERFEIT NOTE” and “STOLEN NOTE”, so that banknote processing can be performed conveniently and efficiently in the same manner as in the case where the serial number list 100 illustrated in FIG. 2A is used.

Note that, the primary recognition and the secondary recognition as described above may be performed during withdrawal processing in which the banknotes stored in the first storage unit 22 or the second storage unit 23 are withdrawn, or during reconciliation processing in which the banknotes stored in the above-mentioned storage units are reconciled. Alternatively, the primary recognition and the secondary recognition as described above may be performed during collection processing in which the banknotes stored in the banknote processing apparatus 1 are collected.

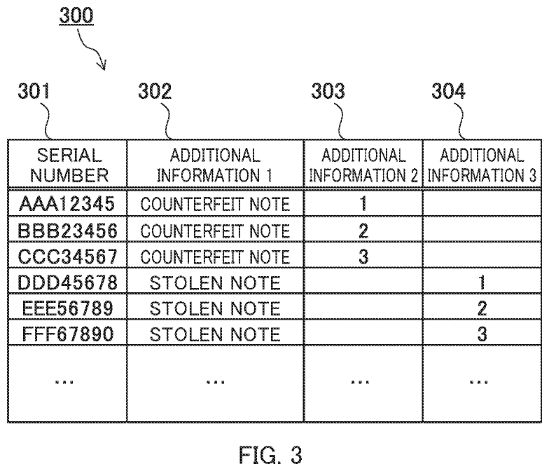

Subsequently, an embodiment of banknote processing using another serial number list will be described. FIG. 3 illustrates a serial number list 300 that is another example of the serial number list. The serial number list 300 is configured with a column 301, a column 302, a column 303, and a column 304.

The column 301 lists serial numbers attached to banknotes that need or may need to be distinguished and processed. The banknotes that need to be distinguished and processed are, for example, counterfeit notes.

The column 302 lists additional information associated with the serial numbers listed in the column 301. The additional information listed in the column 302 is additional information on counterfeit note or stolen note.

The column 303 lists additional information associated with the serial numbers listed in the column 301. The additional information listed in the column 303 is additional information on certainty of counterfeit note. Additional information “1” in the column 303 is information indicating that a banknote to which a serial number corresponding to the additional information “1” is attached is of Counterfeit Note Level 1, that is, is possibly a counterfeit note. Additional information “2” in the column 303 is information indicating that a banknote to which a serial number corresponding to the additional information “2” is attached is of Counterfeit Note Level 2, that is, is more possibly a counterfeit note than the banknote of Counterfeit Note Level 1. Additional information “3” in the column 303 is information indicating that a banknote to which a serial number corresponding to the additional information “3” is attached is of Counterfeit Note Level 3, that is, is much more possibly a counterfeit note than the banknote of Counterfeit Note Level 2, and can be concluded as a counterfeit note.

The column 304 lists additional information associated with the serial numbers listed in the column 301. The additional information listed in the column 304 is additional information on types of stolen note. Additional information “1” in the column 304 is information indicating that a banknote to which a serial number corresponding to the additional information “1” is attached is a stolen note to which a theft mark is not attached. Additional information “2” in the column 304 is information indicating that a banknote to which a serial number corresponding to the additional information “2” is attached is a stolen note to which the theft mark is attached. Additional information “3” in the column 304 is information indicating that a banknote to which a serial number corresponding to the additional information “3” is attached is a stolen note used as a ransom. For example, a banknote processing apparatus such as an automated teller machine (ATM) may record serial numbers of banknotes stored in the inside of the banknote processing apparatus. In a case where a banknote is stolen from an ATM as such, the serial number of the stolen banknote can be specified so that the additional information “1” can be associated with the specified serial number. The same applies to a stolen note used as a ransom. Further, there is a banknote processing apparatus that records serial numbers of banknotes stored in the inside of the banknote processing apparatus and has a function to detect an attempt of unauthorized access to a banknote stored in the inside of the banknote processing apparatus and to attach the theft mark to the banknote. It is possible to specify a serial number of a banknote that is stolen or attempted to be stolen from the banknote processing apparatus as such and to associate the additional information “2” with the specified serial number. An example of commercialized theft marks is a theft mark in which special ink called dye ink adheres to a banknote.

By performing banknote processing using the serial number list 300 as such, it is possible to distinguish banknotes, which should be distinguished, into much more types as needed so that the banknotes can be processed by physically dividing the banknotes as illustrated in Table 1, for example.

TABLE 1

| | Transport destination | | |
|---|---|---|---|
| Recognition Result | Pattern 1 | Pattern 2 | Pattern 3 |
| Genuine note | Each storage unit | Each storage unit | Each storage unit |
| | | (second storage unit) | |
| Counterfeit Note Level 1 | Reject section | Collection storage | Second reject box |
| | | compartment (first | |
| | | storage unit) | |
| Counterfeit Note Level 2 | Reject section | First reject box | Second reject box |
| Counterfeit Note Level 3 | Reject section | First reject box | Second reject box |
| Stolen note to which dye | First reject box | First reject box | First reject box |
| ink adheres | | | |
| Stolen note to which no | First reject box | First reject box | First reject box |
| dye ink adheres | | | |
| Stolen note used as | First reject box | First reject box | First reject box |
| ransom | | | |
| Rejected note | Reject section | Reject section | Reject section |

Table 1 illustrates ways to handle the banknotes in three patterns. In Pattern 1, a genuine note is stored in the first storage unit 22 or the second storage unit 23 that is predetermined depending on denomination and/or the like. Banknotes determined as Counterfeit Note Level 1, Counterfeit Note Level 2, and Counterfeit Note Level 3 are discharged from the reject section 14. Banknotes determined as various stolen notes are stored in the first reject box 18. A banknote determined as a rejected banknote is discharged from the reject section 14.

According to Pattern 1, while a banknote having a slightest chance of being a counterfeit note is returned to the person who has deposited the banknote, it can be ensured that a stolen note is taken in the banknote processing apparatus 1 and is kept therein by physically distinguishing the stolen note from a genuine note.

In Pattern 2, a genuine note is stored in a predetermined storage unit (for example, the second storage unit 23) depending on denomination and/or the like. A banknote determined as Counterfeit Note Level 1 is stored in a collection storage compartment in which banknotes that should be collected are stored (for example, the first storage unit 22). Banknotes determined as Counterfeit Note Level 2 and Counterfeit Note Level 3 are stored in the first reject box 18. Banknotes determined as various stolen notes are stored in the first reject box 18. A banknote determined as a rejected banknote is discharged from the reject section 14.

According to Pattern 2, a banknote that is possibly a counterfeit note, but with low accuracy, is allowed to be deposited as a genuine note and is then withdrawn during depositing processing so that the banknote can be prevented from being transferred to the hands of a person other than the person who has deposited the banknote. Further, it can be ensured that that a banknote that is a counterfeit note with high accuracy and various stolen notes are taken in the banknote processing apparatus 1, and are kept therein by physically distinguishing the banknote and the various stolen notes from genuine notes.

In Pattern 3, a genuine note is stored in the first storage unit 22 or the second storage unit 23 that is predetermined depending on denomination and/or the like. Banknotes determined as Counterfeit Note Level 1, Counterfeit Note Level 2, and Counterfeit Note Level 3 are stored in the second reject box 24. Banknotes determined as various stolen notes are stored in the first reject box 18. A banknote determined as a rejected banknote is discharged from the reject section 14.

According to Pattern 3, while a banknote having a slightest chance of being a counterfeit note and various stolen notes are physically distinguished, it can be ensured that the banknote and the various stolen notes are taken in the banknote processing apparatus 1, and are kept therein by distinguishing the banknote and the various stolen notes from genuine notes.

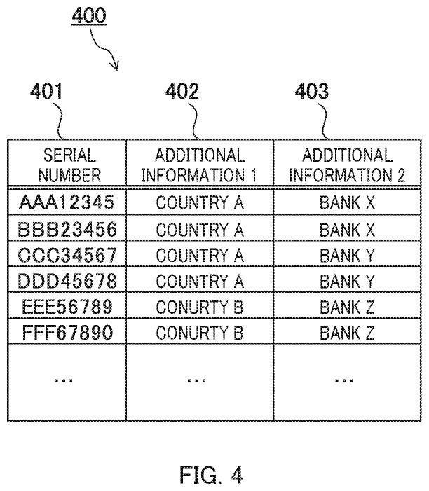

Subsequently, an embodiment of banknote processing using another serial number list will be described. FIG. 4 illustrates a serial number list 400 that is an example of the serial number list. The serial number list 400 is configured with a column 401, a column 402, and a column 403.

The column 401 lists serial numbers attached to banknotes that need or may need to be distinguished and processed. The banknotes that need to be distinguished and processed are, for example, counterfeit notes.

The column 402 lists additional information associated with the serial numbers listed in the column 401. The additional information listed in the column 402 is additional information on types of currencies to which banknotes belong.

The column 403 lists additional information associated with the serial numbers listed in the column 401. The additional information listed in the column 403 is additional information on institutions (for example, banks) that issue the banknotes.

By using the serial number list 400 as such, the banknote processing apparatus 1 is capable of performing the following banknote processing. For example, a case is supposed where the serial numbers listed in the column 401 are serial numbers attached to counterfeit notes. In this case, when banknotes to which serial numbers associated with additional information “COUNTRY A” in the column 402 are attached are processed by distinguishing the banknotes from other banknotes, the counterfeit notes forged by imitating banknotes of Country A can be processed by distinguishing the banknotes from other banknotes.

Alternatively, when banknotes to which serial numbers associated with additional information “BANK X” in the column 403 are attached are processed by distinguishing the banknotes from other banknotes, the counterfeit notes forged by imitating banknotes issued by Bank X can be processed by distinguishing the banknotes from other banknotes.

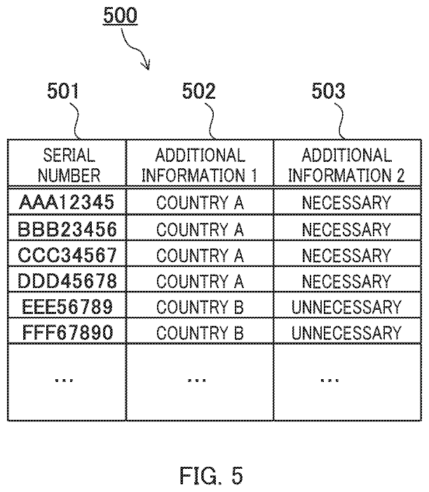

Subsequently, an embodiment of banknote processing using further another serial number list will be described. FIG. 5 illustrates a serial number list 500 that is an example of the serial number list. The serial number list 500 is configured with a column 501, a column 502, and a column 503.

The column 501 lists serial numbers attached to banknotes that need or may need to be distinguished and processed. The banknotes that need to be distinguished and processed are, for example, counterfeit notes.

The column 502 lists additional information associated with the serial numbers listed in the column 501. The additional information listed in the column 502 is additional information on types of currencies to which banknotes belong.

The column 503 lists additional information indicating whether or not banknotes to which the serial numbers listed in the column 501 are attached needs to be distinguished. There is a case where all the serial numbers comprised in the serial number list 500 do not need to be distinguished depending on conditions of using the banknote processing apparatus 1. For example, information “NECESSARY” is attached to boxes corresponding to serial numbers that need to be distinguished in the column 503, and information “UNNECESSARY” is attached to boxes corresponding to serial numbers that do not need to be distinguished in the column 503. Serial numbers whose additional information in the column 503 is “UNNECESSARY” are not subjected to matching processing with the read serial numbers in the secondary recognition. Note that, when needed, all the serial numbers comprised in the serial number list 500 can be regarded as unnecessary to be distinguished.

As a result of a specific serial number listed in the column 501 being directly designated, the banknote processing apparatus 1 is capable of determining whether or not the specific serial number in the serial number list 500 is attached to a banknote. Conversely, it is also possible not to allow the banknote processing apparatus 1 to determine whether or not the directly designated specific serial number is attached to a banknote.

Further, as a result of a specific serial number listed in the column 501 being designated based on other additional information, the banknote processing apparatus 1 is capable of determining whether or not the specific serial number in the serial number list 500 is attached to a banknote. Conversely, it is also possible not to allow the banknote processing apparatus 1 to determine whether or not the specific serial number designated based on the other additional information is attached to a banknote. Based on the serial number list 500, it is determined whether or not a serial number of a banknote of Country A is attached to a banknote. Conversely, no determination is performed as to whether or not a serial number of a banknote of Country B is attached to a banknote.

As is apparent from the above, the banknote processing apparatus 1 is capable of determining whether or not a specific serial number comprised in a serial number list is attached to a banknote. In other words, the banknote processing apparatus 1 is capable of setting whether or not the secondary recognition for a specific serial number comprised in a serial number list is performed.

Further, the banknote processing apparatus 1 is capable of recording a plurality of serial number lists. In this case, it is possible to set whether or not the secondary recognition is performed for each serial number list. As a result of a specific serial number list in a plurality of serial number lists being directly designated, the banknote processing apparatus 1 is capable of performing the secondary recognition based on the specific serial number list. Conversely, it is also possible not to allow banknote processing apparatus 1 to perform the secondary recognition based on the directly designated specific serial number list.

Further, as a result of a specific serial number list in a plurality of serial number lists being designated based on the other additional information, the banknote processing apparatus 1 is capable of performing the secondary recognition based on the specific serial number list. Conversely, it is also possible not to allow the banknote processing apparatus 1 to perform the secondary recognition based on the specific serial number designated based on the other additional information. For example, in a case where the additional information in a serial number list comprises “WORKER” and/or “LOCATION WHERE A BANKNOTE PROCESSING APPARATUS IS INSTALLED”, both the additional information being described later, a serial number list that is used for the secondary recognition or a serial number list that is not used for the secondary recognition may be specified based on the additional information of “WORKER” and/or “LOCATION WHERE A BANKNOTE PROCESSING APPARATUS IS INSTALLED”.

Note that, the additional information that each of the serial number lists 100 to 500 comprises may be the following additional information instead of or in addition to the additional information described so far. It is needless to say that the following additional information is exemplary.

(1) New and Old Series Banknotes

In a case where information on old or new series banknotes (an old series banknote before a design change or a new series banknote after the design change) is comprised as the additional information, the banknotes can be processed by distinguishing the banknotes between old and new series banknotes. For example, the banknotes to be processed can be only new series banknotes or conversely only old series banknotes. Alternatively, only in respect of old series banknotes, for example, the banknotes can be processed by distinguishing the banknotes as to whether or not the banknotes are counterfeit notes.

(2) Worker

In a case where information on a worker who operates the banknote processing apparatus 1 to execute banknote processing work is comprised as the additional information, the banknotes to be distinguished and processed can be changed depending on the worker. For example, in a case where the banknote processing apparatus 1 is installed in a bank and both a teller and a store customer may operate the banknote processing apparatus 1, a banknote can be processed by distinguishing the banknote as to whether or not the banknote is a counterfeit note, only when the store customer works with the banknote processing apparatus 1. Note that, the information on who operates the banknote processing apparatus 1 can be obtained from e.g. an ID that is input at the time of starting the operation.

(3) Location where a Banknote Processing Apparatus is Installed

In a case where information on a location where the banknote processing apparatus 1 is installed is comprised as the additional information, the banknotes to be distinguished and processed can be changed depending on the installation location. For example, a banknote can be processed by distinguishing the banknote as to whether or not the banknote is a counterfeit note, only when the banknote processing apparatus 1 is installed in a retail store and may be operated by an unspecified number of people.

Note that, there may be several types of serial number lists. For example, a serial number list that relates to counterfeit notes forged in one region may be created and used in the one region, and a serial number list that relates to counterfeit notes forged in another region may be created and used in the other region. Even in such a case, a counterfeit note may be brought from the one area where the counterfeit note is forged to the other area for use.

Accordingly, to distinguish and process every counterfeit note, the banknote processing apparatus 1 needs to cause every serial number list to be recorded in the memory that the control section 19 comprises. However, the more serial number lists there are, the more difficult it is to cause every serial number list to be recorded in the memory that the banknote processing apparatus 1 comprises. Further, the contents of the same serial number list may change due to a version upgrade. It is even more difficult to cause up-to-date versions of every serial number list to be recorded in the memory that one banknote processing apparatus, namely the banknote processing apparatus 1, comprises.

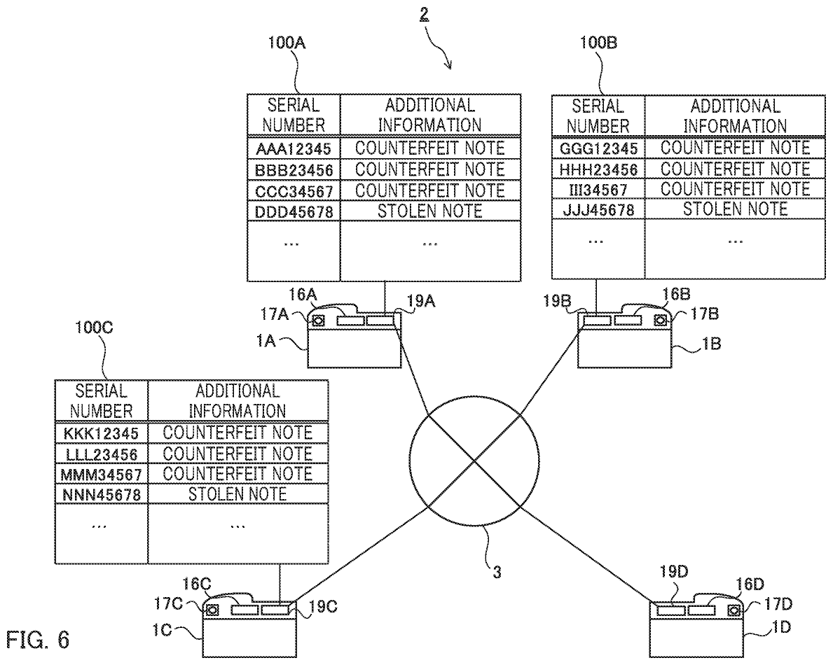

Such a disadvantage can be eliminated by a banknote processing system 2 illustrated in FIG. 6. The banknote processing system 2 is configured with four banknote processing apparatuses 1A to 1D that are connected through a network 3. Each of the banknote processing apparatuses 1A to 1D is capable of communicating with each other through the network 3. Each of the banknote processing apparatuses 1A to 1D is configured in the same manner as the banknote processing apparatus 1 described above. That is, the banknote processing apparatuses 1A to 1D each comprise recognition units 16A to 16D, temporary storage sections 17A to 17D, control sections 19A to 19D and the like, respectively. Note that, it is needless to say that the number of banknote processing apparatuses that configure the banknote processing system 2 may be any number as long as the number is two or more.

The control section 19A that the banknote processing apparatus 1A comprises records a serial number list 100A in a memory of the control section 19A. The configuration and contents of the serial number list 100A are the same as those of the serial number list 100 described above.

The control section 19B that the banknote processing apparatus 1B comprises records a serial number list 100B in a memory of the control section 19B. The configuration of the serial number list 100B is the same as that of the serial number list 100 described above. However, serial numbers listed in the serial number list 100B differ from those listed in the serial number list 100.

The control section 19C that the banknote processing apparatus 1C comprises records a serial number list 100C in a memory of the control section 19C. The configuration of the serial number list 100C is the same as that of the serial number list 100 described above. However, serial numbers listed in the serial number list 100C differ from those listed in the serial number list 100.

The control section 19D that the banknote processing apparatus 1D comprises does not record any serial number list in a memory of the control section 19D.

Note that, the serial numbers that each of the serial number lists 100A to 100C comprises may be completely different from each other or may partially overlap with each other. Further, additional information that each of the serial number lists 100A to 100C comprises may be the same each other or different from each other. Further, each of the serial number lists 100A to 100C may also be the same serial number list with different versions. Note that, a version of a serial number list will be described later.

In the banknote processing system configured as described above, in a case where the banknote processing apparatus 1A processes a banknote, the recognition unit 16A and the control section 19A that the banknote processing apparatus 1A comprises perform the primary recognition. Then the recognition unit 16A and the control section 19A perform the secondary recognition. In this case, a serial number read by the recognition unit 16A is sent to the banknote processing apparatus 1B and the banknote processing apparatus 1C through the networks 3.

Upon reception of the serial number, the banknote processing apparatus 1B uses the serial number to perform recognition processing similar to the secondary recognition. That is, the control section 19B that the banknote processing apparatus 1B comprises performs matching whether or not the received serial number is comprised in the serial number list 100B recorded in the memory that the control section 19B comprises. That is, it is determined whether or not the banknote to which the received serial number is attached is a banknote to be distinguished.

In a case where the received serial number is comprised in the serial number list 100B, the banknote processing apparatus 1B sends information on the fact that the received serial number is comprised in the serial number list 100B, and on the additional information associated with the serial number to the banknote processing apparatus 1A. In a case where the received serial number is not comprised in the serial number list 100B, the banknote processing apparatus 1B sends information on the fact that the received serial number is not comprised in the serial number list 100B to the banknote processing apparatus 1A.

The banknote processing apparatus 1C also functions in the same manner as the banknote processing apparatus 1B by using the serial number list 100C.

The banknote processing apparatus 1A performs final determination as to whether or not the recognized banknote needs to be processed by distinguishing the banknote from other banknotes based on the result of the secondary recognition performed by the banknote processing apparatus 1A itself, the information received from the banknote processing apparatus 1B, and the information received from the banknote processing apparatus 1C. How the banknote is processed as a result of the determination is as described above with respect to the banknote processing apparatus 1.

Thus, according to the banknote processing system 2, it is possible to efficiently perform determination processing by dispersing the determination processing using a plurality of the banknote processing apparatuses 1A to 1C.

Note that, in a case where it takes a relatively long time to receive the information from the banknote processing apparatus 1B and the banknote processing apparatus 1C, a banknote to be processed may be once stored in the temporary storage section 17A. After the information from the banknote processing apparatus 1B and the banknote processing apparatus 1C is received, the banknote can be appropriately processed based on the received information. It is needless to say that the banknote processing apparatus 1A is capable of performing banknote processing substantially in real time in a case where information processing speeds in the banknote processing apparatus 1B and the banknote processing apparatus 1C as well as a communication speed through the network 3 are sufficiently high.

According to the banknote processing system 2 as such, a banknote can be appropriately processed even when one banknote processing apparatus that is the banknote processing apparatus 1A does not cause every necessary serial number list to be recorded in the memory of the banknote processing apparatus 1A.

Further, the banknote processing apparatus 1D is capable of performing banknote processing as follows. First, the recognition unit 16D and the control section 19D perform the primary recognition, and read a serial number from a banknote. Subsequently, the serial number read from the banknote is sent to the banknote processing apparatuses 1A to 1C through the network 3.

Upon reception of the serial number, the banknote processing apparatus 1A uses the serial number to perform recognition processing similar to the secondary recognition. That is, the control section 19A that the banknote processing apparatus 1A comprises performs matching whether or not the received serial number is comprised in the serial number list 100A recorded in the memory that the control section 19A comprises. That is, it is determined whether or not the banknote to which the received serial number is attached is a banknote to be distinguished.

In a case where the received serial number is comprised in the serial number list 100A, the banknote processing apparatus 1A sends information on the fact that the received serial number is comprised in the serial number list 100A, and on the additional information associated with the serial number to the banknote processing apparatus 1D. In a case where the received serial number is not comprised in the serial number list 100A, the banknote processing apparatus 1A sends information on the fact that the received serial number is not comprised in the serial number list 100A to the banknote processing apparatus 1D.

The banknote processing apparatus 1B and the banknote processing apparatus 1C also function in the same manner as the banknote processing apparatus 1A by using the serial number list 100B and the serial number list 100C.

The banknote processing apparatus 1D performs final determination as to whether or not the recognized banknote needs to be processed by distinguishing the banknote from other banknotes based on the information received from the banknote processing apparatuses 1A to 1C. How the banknote is processed as a result of the determination is as described above with respect to the banknote processing apparatus 1.

That is, by utilizing the banknote processing system 2, the banknote processing apparatus 1D is capable of processing a banknote that needs to be distinguished and processed by distinguishing the banknote from other banknotes even though the banknote processing apparatus 1D does not cause any serial number list to be recorded in the memory of the banknote processing apparatus 1D.

Further, the control section 19A that the banknote processing apparatus 1A comprises may record other apparatus information that is information on the banknote processing apparatuses 1B to 1D. The other apparatus information is information on serial number lists on which the control sections 19B to 19D that the banknote processing apparatuses 1B to 1D comprise are based when performing banknote processing.

Specifically, the other apparatus information is information that the control section 19B and the control section 19C are based on the serial number list 100B and the serial number list 100C, respectively, when performing banknote processing, and that the control section 19D does not comprise any serial number list on which the control section 19D is based when performing banknote processing.

In a case where the control section 19A records the other apparatus information as such, the banknote processing apparatus 1A is capable of selecting a banknote processing apparatus(es), which record(s) a serial number list(s) that should be matched, from the banknote processing apparatuses 1B to 1D based on the other apparatus information, and then sending the serial number to only a specific banknote processing apparatus(es).

Accordingly, by using the other apparatus information, it is possible to efficiently perform determination processing by dispersing the determination processing among a plurality of banknote processing apparatuses.

Further, in a case where determination processing is performed by dispersing the determination processing among a plurality of banknote processing apparatuses, the banknote processing apparatus 1A that actually performs banknote processing, for example, may tentatively perform banknote processing before receiving the information from another banknote processing apparatus such as the banknote processing apparatus 1B. In a case where the tentatively performed processing is not appropriate based on the information received from another banknote processing apparatus such as the banknote processing apparatus 1B, an appropriate processing can be performed afterward.

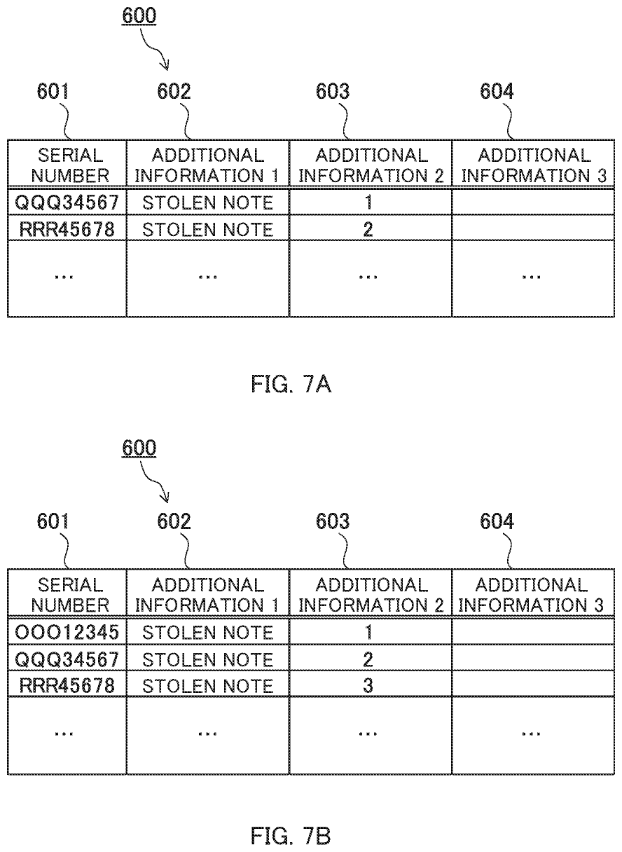

Note that, by collecting and analyzing a plurality of results of the primary recognition, credibility of a serial number list can be enhanced and a version of the serial number list can be upgraded. Hereinafter, a description will be given of how to upgrade a version of a serial number list by using a serial number list 600 illustrated in FIG. 7A as an example. Note that, a column 601, a column 602, a column 603, and a column 604 of the serial number list 600 correspond to the column 301, the column 302, the column 303, and the column 304 of the serial number list 300, respectively.

Table 2 illustrates a plurality of primary recognition results of banknotes.

TABLE 2

| Ser. | Primary Recognition | | Processing | |
|---|---|---|---|---|
| No. | Result | Maker | apparatus ID | Date |
| OOO12345 | Counterfeit Note | α | 1A | 1/10/YYYY |
| PPP23456 | Suspected of | α | 1A | 2/10/YYYY |
| | Counterfeit Note | | | |
| QQQ34567 | Counterfeit Note | α | 1A | 3/10/YYYY |
| RRR45678 | Counterfeit Note | β | 1B | 4/10/YYYY |
| . | . | . | . | . |
| . | . | . | . | . |
| . | . | . | . | . |

Table 2 indicates, for example, that a banknote to which a serial number “OOO12345” is attached is processed on October 1, YYYY (year) by the banknote processing apparatus 1A manufactured by a maker “α”. Further, it means that the banknote is determined as a counterfeit note as a result of the primary recognition since fluorescent light that is to be emitted originally is not emitted in the above case, for example.

Further, Table 2 indicates, for example, that a banknote to which a serial number “PPP23456” is attached is processed on October 2, YYYY (year) by the banknote processing apparatus 1A manufactured by the maker “α”. Further, it means that the banknote is determined as a counterfeit note as a result of the primary recognition since fluorescent light slightly different from the fluorescent light that is to be emitted originally is not emitted in the above case, for example.

Table 3 is obtained by collecting and aggregating such information for a predetermined period.

TABLE 3

| | Counterfeit | Suspected of |
|---|---|---|
| Ser. No. | Note | Counterfeit Note |
| OOO12345 | 1 | 0 |
| PPP23456 | 0 | 1 |
| QQQ34567 | 5 | 6 |
| RRR45678 | 10 | 20 |
| . | . | . |
| . | . | . |
| . | . | . |

Table 3 indicates information that the banknote to which the serial number “OOO12345” is attached is determined once as a counterfeit note, and that the banknote to which the serial number “PPP23456” is attached is determined once as being suspected of a counterfeit note. Further, Table 3 indicates information that a banknote to which a serial number “QQQ34567” is attached is determined five times as a counterfeit note, and six times as being suspected of a counterfeit note. Further, Table 3 indicates information that a banknote to which a serial number “RRR45678” is attached is determined ten times as a counterfeit note, and twenty times as being suspected of a counterfeit note. Note that, numerous counterfeit notes may be forged from a single plate. Accordingly, it may occur that counterfeit notes to which the same serial number is attached are processed a plurality of times by a plurality of banknote processing apparatuses.

A version of the serial number list 600 can be upgraded based on the abovementioned information and predetermined criteria. The predetermined criteria are, for example, as follows. (1) When a serial number is determined once or more as involving a counterfeit note or five times or more as involving being suspected of a counterfeit note, a banknote to which the serial number is attached is possibly a counterfeit note. (2) When a serial number is determined five times or more as involving a counterfeit note or ten times or more as involving being suspected of a counterfeit note, a banknote to which the serial number is attached is highly possibly a counterfeit note. (3) When a serial number is determined ten times or more as involving a counterfeit note, a banknote to which the serial number is attached can be concluded as a counterfeit note.

As a result of the version upgrade, as illustrated in FIG. 7B, a serial number “OOO12345” that is not listed before the version upgrade is added to the column 601, and additional information “COUNTERFEIT NOTE” is associated with the serial number as illustrated in the column 602, and additional information “1” is associated with the serial number as illustrated in the column 603. That is, information that the banknote to which the serial number “OOO12345” is attached is possibly a counterfeit note is added to the serial number list 600 by the version upgrade.

Further, although the serial number “QQQ34567” is associated with the additional information “1” in the column 603 before the version upgrade, the serial number “QQQ34567” is associated with additional information “2” after the version upgrade. That is, the information that the banknote to which the serial number “QQQ34567” in the serial number list 600 is attached is updated by the version update from “possibly a counterfeit note” to “highly possibly a counterfeit note”.

Further, although the serial number “RRR45678” is associated with the additional information “2” in the column 603 before the version upgrade, the serial number “RRR45678” is associated with additional information “3” after the version upgrade. That is, the information that the banknote to which the serial number “RRR45678” in the serial number list 600 is attached is updated by the version update from “highly possibly a counterfeit note” to “can be concluded as a counterfeit note”.

Note that, the serial number “PPP23456” is not added to the serial number list 600 by the version upgrade.

It is also possible to create a new serial number list by using the above-described technique.

Further, the banknote processing apparatus 1A may also register based on which version of which serial number list the secondary recognition is performed. By doing so, validity of a secondary recognition result or validity of a serial number list on which the secondary recognition is based can be verified afterward.

Although some embodiments of the present invention have been described thus far, the present invention is not limited to each of the embodiments described above, and various modifications are possible without departing from the spirit of the present invention. For example, processing similar to the processing described by using one of the serial number lists 100 to 600 as an example may be performed using another of the serial number lists 100 to 600.

Further, the sheet processing apparatus and the sheet processing system are not limited to the banknote processing apparatus and the banknote processing system, and may be an apparatus and a system for processing other sheets such as checks and vouchers.

This application is entitled to the benefit of Japanese Patent Application No. 2017-233511, filed on Dec. 5, 2017, the disclosure of which including the specification, drawings and abstract is incorporated herein by reference in its entirety.

### INDUSTRIAL APPLICABILITY

The present invention is suitable for use as a sheet processing apparatus and a sheet processing system.

### REFERENCE SIGNS LIST

1, 1A, 1B, 1C, 1D Banknote processing apparatus
10 Processing section
11 Upper housing
12 Depositing section
12a Inlet
13 Withdrawal section
13a Outlet
14 Reject section
14a Reject port
15 Transport unit
16, 16A, 16B, 16C, 16D Recognition unit
17, 17A, 17B, 17C, 17D Temporary storage section
18 First reject box
19, 19A, 19B, 19C, 19D Control section
20 Storage compartment
21 Lower housing
22 First storage unit
23 Second storage unit
24 Second reject box
100, 200, 300, 400, 500, 100A, 100B, 100C, 600 Serial number list
101, 102, 201, 202, 301, 302, 303, 304, 401, 402, 403, 501, 502, 503, 601, 602, 603, 604 Column
2 Banknote processing system
3 Network

1. A sheet processing apparatus, comprising:
a recognition unit that recognizes a serial number attached to a sheet; and
a control section that executes determination of the sheet based on the serial number recognized by the recognition unit, and a serial number list including a plurality of serial numbers and additional information associated with at least one of the plurality of serial numbers.

2. The sheet processing apparatus according to claim 1, wherein
the control section determines that the sheet corresponds to the additional information in a case that at least one of the plurality of serial numbers in the serial number list coincides with the serial number recognized by the recognition unit and that the additional information is associated with the at least one of the plurality of serial numbers in the serial number list.

3. The sheet processing apparatus according to claim 1, wherein
the serial number list comprises a plurality of types of the additional information.

4. The sheet processing apparatus according to claim 1, wherein
the additional information comprises information on authenticity of the sheet.

5. The sheet processing apparatus according to claim 1, wherein
the additional information comprises information on certainty of the authenticity of the sheet.

6. The sheet processing apparatus according to claim 1, wherein
the additional information comprises information on theft of the sheet.

7. The sheet processing apparatus according to claim 1, further comprising a transport unit connected to a plurality of transport destinations, wherein
the control section selects one transport destination from the plurality of transport destinations based on a result of the determination.

8. The sheet processing apparatus according to claim 1, wherein
the control section executes the determination for a specific serial number in the serial number list.

9. The sheet processing apparatus according to claim 8, wherein
the specific serial number is associated with a specific additional information in the serial number list.

10. The sheet processing apparatus according to claim 1, wherein
the control section executes the determination based on how the sheet processing apparatus is used.

11. The sheet processing apparatus according to claim 1, wherein
the control section executes the determination when the sheet processing apparatus executes specific processing.

12. A sheet processing system, comprising:
a first sheet processing apparatus that is the sheet processing apparatus according to claim 1; and
a second sheet processing apparatus that is the sheet processing apparatus according to claim 1 and is connected to the first sheet processing apparatus through a network, wherein
a first control section of the first sheet processing apparatus executes the determination based on a recognition result by a recognition unit of the first sheet processing apparatus, and
a second control section of the second sheet processing apparatus executes the determination based on the recognition result by the recognition unit of the first sheet processing apparatus, the recognition result being received through the network.

13. The sheet processing system according to claim 12, wherein
the first control section executed the determination based on a first serial number list, and the second control section executes the determination based on a second serial number list, and the first serial number list and the serial number list differ from each other.

14. The sheet processing system according to claim 12, wherein
the first control section records other apparatus information that is information on the serial number list on which the second control section is based when executing the determination, and transmits the recognition result by the recognition unit included in the first sheet processing apparatus to the second sheet processing apparatus through the network based on the other apparatus information.

15. The sheet processing system according to claim 12, wherein
the first sheet processing apparatus receives information on a result of the determination by the second sheet processing apparatus through the network.
